(19) United States
(12) Patent Application Publication
(10) Pub. No.: US 2008/0270589 A1
(43) Pub. Date: Oct. 30, 2008

(54) Multi-Source, Multi-Use Web Processing Through Dynamic Proxy Based Grid Computing Mechanisms

(75) Inventor: Junseok Hwang, Seoul (KR)

Correspondence Address: FISH & RICHARDSON P.C., PO BOX 1022, MINNEAPOLIS, MN, 55440-1022, US

(73) Assignee: beGrid, Inc.

(21) Appl. No.: 12/058,536

(22) Filed: Mar. 28, 2008

Related U.S. Application Data
(60) Provisional application No. 60/908,760, filed on Mar. 29, 2007.

(51) Int. Cl. G06F 15/173

(52) U.S. Cl. 709/223

(57) ABSTRACT

Various implementations are disclosed for service independent, scalable, multi-source, multi-user (MSMU) Web processing and transactions through dynamic proxy based grid computing mechanisms.

### RELATED APPLICATION

This application claims the benefit of priority of U.S. Provisional Patent Application No. 60/908,760, filed Mar. 29, 2007, which provisional patent application is incorporated by reference herein in its entirety.

### TECHNICAL FIELD

This subject matter is generally related to computer network architectures.

### BACKGROUND

Grid computing virtualizes computing resources by sharing geographically distributed heterogeneous resources belonging to different administrative domains over a network using open standards. Conventional grid computing infrastructures, such as the Open Grid Services Architecture (OGSA) developed within the Global Grid Forum (GGF), are typically used to solve complex problems in science that cannot be solved easily on a single supercomputer. OGSA and other conventional grid computing infrastructures do not provide individual end users (as opposed to business enterprises and universities) access to virtualized applications and services.

The allocation of resources in conventional grid computing infrastructures is commonly done in accordance with service level agreements and other contractual arrangements between resource providers, distributors and end users. Such contractual arrangements, and the associated transaction costs, prevent conventional grid computing infrastructures from providing individual end users worldwide access to geographically distributed heterogeneous resources.

### SUMMARY

The deficiencies described above are overcome by service independent, scalable, multi-source, multi-use (MSMU) World Wide Web (“Web”) processing and transactions through dynamic proxy based grid computing mechanisms. The disclosed implementations are more scalable and flexible than conventional client/server architectures. The disclosed implementations are more efficient than conventional peer-to-peer (P2P) networks due to the inclusion of a control layer for controlling processes in the distributed infrastructure. The disclosed implementations provide virtualized applications and services which are typically not provided by conventional grid computing infrastructures.

### DESCRIPTION OF DRAWINGS

FIG. 1 is a block diagram illustrating an example of a grid based MSMU dynamic proxy based Web service architecture.

FIGS. 2A-2C is a flow diagram illustrating an example of a grid based MSMU dynamic proxy based Web process.

FIG. 3 illustrates an example of a software architecture for the control layer of FIG. 1.

FIG. 4 illustrates an example of an open source building block service for use with the architecture and processes described in reference to FIGS. 1 and 2A-2C.

FIG. 5 is a flow diagram illustrating an example of a global search service.

FIG. 6 is a flow diagram illustrating an example of a global encyclopedia service.

FIG. 7 is a flow diagram illustrating an example of a global filter service.

FIG. 8 is a flow diagram illustrating an example of a three-dimensional (3D) transform service.

FIG. 9 is a flow diagram illustrating an example of a personalized multimedia content studio service.

FIG. 10 is a flow diagram illustrating an example of a global Web pen pal service.

FIG. 11 is a flow diagram illustrating an example of a global publishing service.

FIG. 12 is a block diagram illustrating an example of an architecture of the user devices or source devices of FIG. 1.

### DETAILED DESCRIPTION

### Architecture Overview

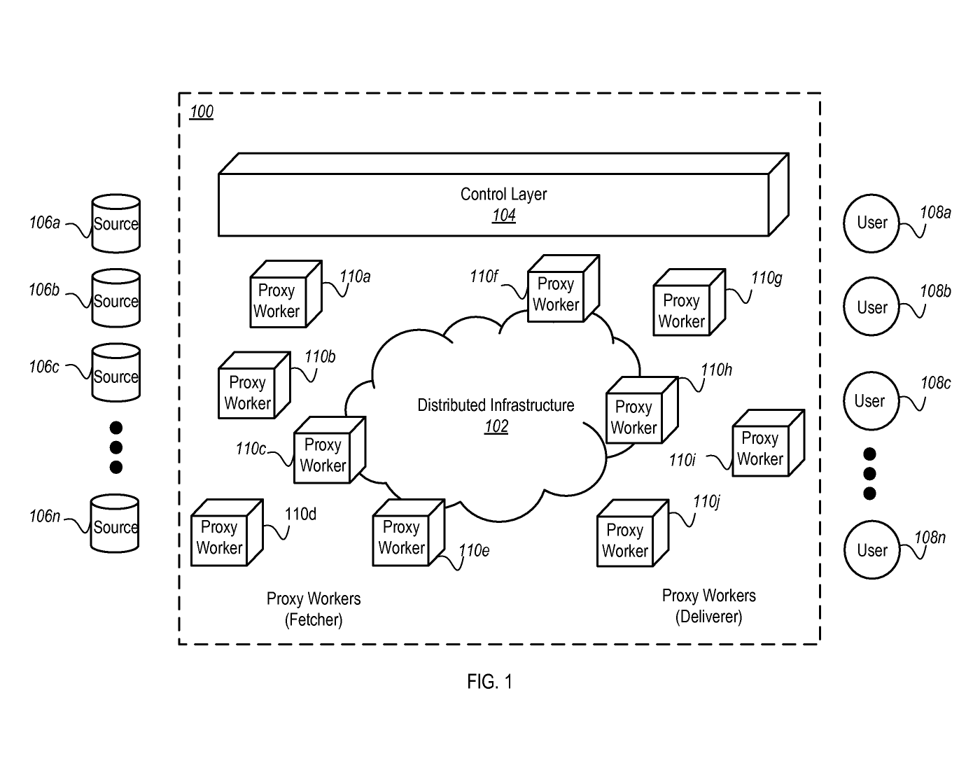

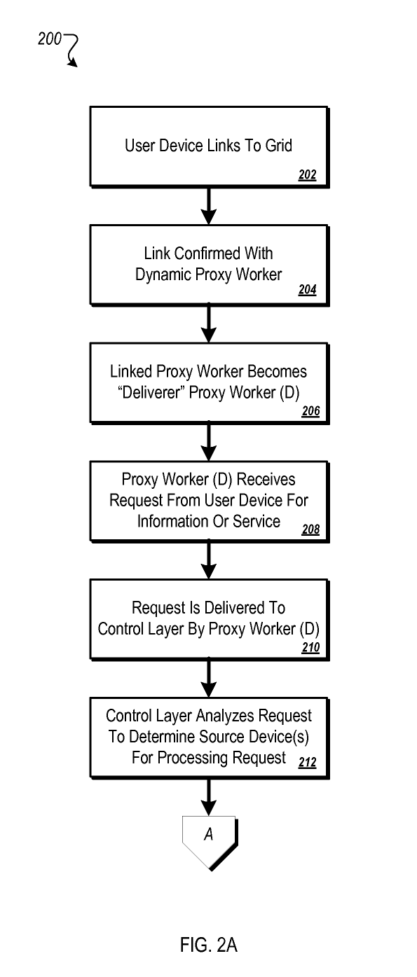

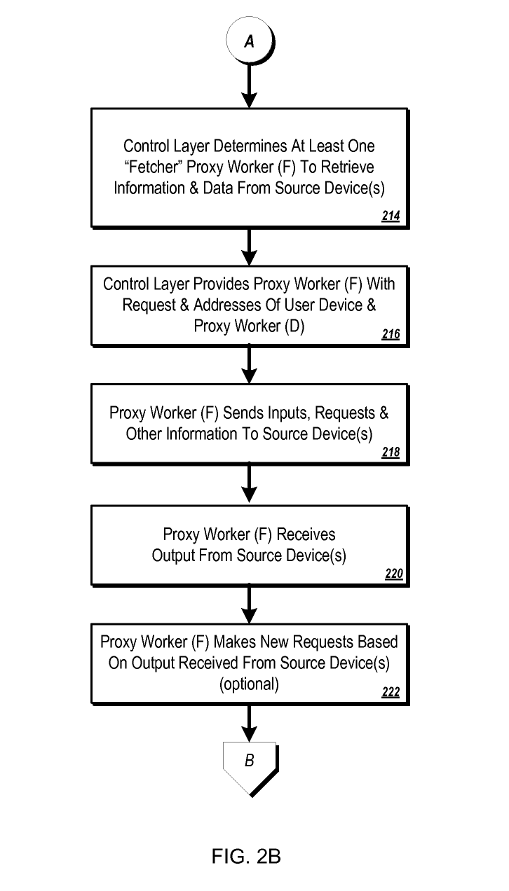

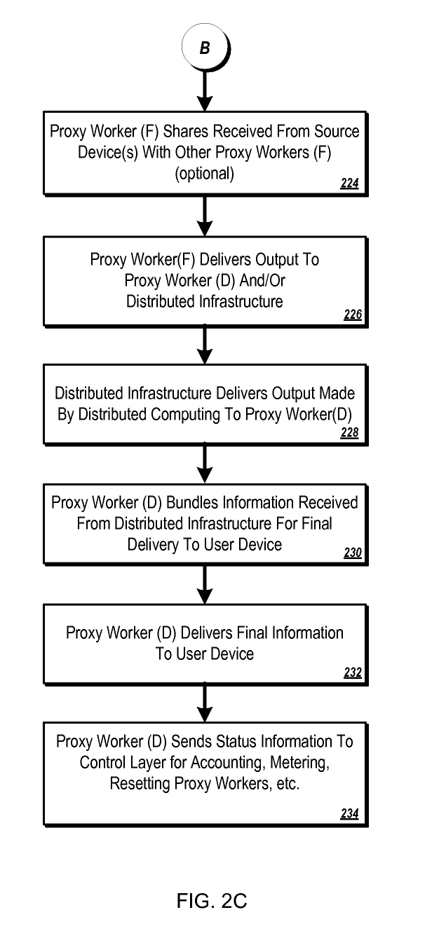

FIG. 1 is a block diagram illustrating an example of a grid based MSMU dynamic proxy based Web service grid 100 (hereinafter, also referred to as “grid 100”). In the example shown, the grid 100 generally includes a distributed infrastructure 102 and a control layer 104. The control layer 104 is operable to generate and manage a number of dynamic proxy workers 110. The dynamic proxy workers 110 provide links for source devices 106 and user devices 108 to access the distributed infrastructure 102. The dynamic proxy workers 110 also provide fetch and deliver operations for the grid 100, as described in reference to FIGS. 2A-2C.

The distributed infrastructure 102 can include any devices having processing capability, including but not limited to: servers, routers, hubs, personal computers, mobile phones, media players/recorders, game consoles, personal digital assistants (PDAs), email devices, navigation systems, television systems and set-top boxes, etc.

The various devices comprising the distributed infrastructure 102 can communicate using a variety of known and/or standardized communication protocols, including but not limited to: Web Services Description Language (WSDL) and Simple Object Access Protocol (SOAP), Transmission Control Protocol/Internet Protocol (TCP/IP), Ad Hoc Wireless Distribution Service (AWDS), User Datagram Protocol (UDP), Internet Control Message Protocol (ICMP), Wireless Application Protocol (WAP), Wi-Fi, World Wide Interoperability for Microwave Access (WiMax), etc.

The various devices comprising the distributed infrastructure 102 can host a variety of applications and operating systems using a variety of known and/or standardized technologies and platforms, including but not limited to: Extensible Markup Language (XML), Hypertext Markup Language (HTML), JavaScript®, Java® 2 Platform Enterprise Edition (j2EE), etc.

In some implementations, the user devices 108 can be any heterogeneous device with network connectivity. The user devices 108 can run a variety of known platforms (e.g., Windows®, Mac® OS, Palm® OS, Linux® OS, Unix® or any version thereof), and can be coupled to, or integrated with, a variety of peripheral and I/O devices. The user devices 108 can include any type or capacity of memory (e.g., RAM, ROM, flash) or storage media (e.g., hard disk, optical disk, USB flash drive, storage area network (SAN)).

In some implementations, the source devices 106 can be any device with network connectivity and accessible data and information, such as, for example, Web servers, database servers, data storage devices or any of the user devices 108, as previously described herein.

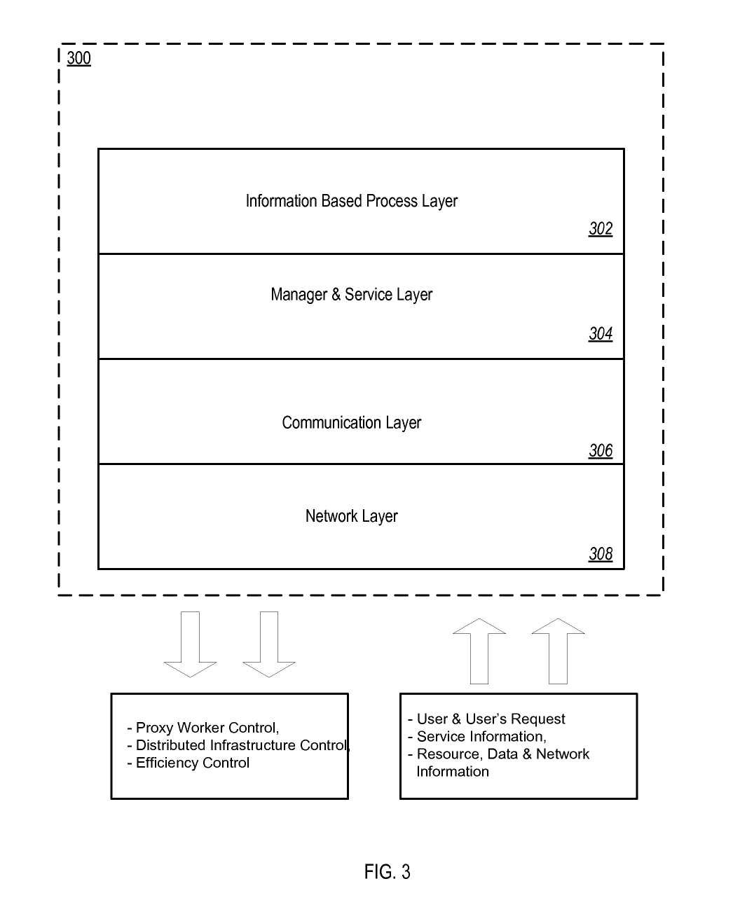

In some implementations, the control layer 104 includes a number of functional layers, a communication and a network layer, as described in reference to FIG. 3. The control layer 104 can be implemented as one or more software processes, which provide efficient control of the grid 100, including but not limited to managing and monitoring Web services and dynamic proxy workers 110.

In some implementations, the dynamic proxy workers 110 are temporary, dynamically distributed processes created by the control layer 104 for performing various jobs throughout the grid 100 as needed. The dynamic proxy workers 110 can process jobs or requests provided by the control layer 104 and other devices in the grid 100, including but not limited to: source devices 106, user devices 108, other dynamic proxy workers 110, etc. In some implementations, dynamic proxy workers can by implemented using known software tools, such as the Java® dynamic proxy Application Programming Interface (API), classes, methods, etc.

In some implementations, dynamic proxy workers 110 can be developed and created using Java® based middleware and any other grid development tools. The dynamic proxy workers 110 can communicate with each other and Java® based grid brokers using, for example, TCP/IP with an XML data format.

The control layer 104 can be created and used by several Java based grid brokers which communicate with each other using APIs, such as service-redirection and load-balance-transaction. When brokers communicate and control each other in the control layer 104, a broker virtualizes the other broker as a proxy worker through a proximization API.

### PROCESS EXAMPLE

FIGS. 2A-2C are flow diagrams illustrating an example of a grid based MSMU dynamic proxy based Web process 200. Some or all of steps of the process 200 can be implemented sequentially and/or in parallel, using a number of devices, protocols and technologies, as previously described herein.

In some implementations, the process 200 begins when a user device links to a grid (202). The user device can be manually or automatically linked to the grid through an access point (e.g., Internet, Ethernet, wireless network). A control layer or device in the grid can provide a Web page or other user interface that a user can log into and gain access to the grid and Web services. For example, a Web page for accessing the grid can be served by a Web server in the grid. In some implementations, a user device can include an access application or plug-in that can be invoked by a user or application running on the user device to provide access to the grid.

In some implementations, when the user links to the grid, the link is confirmed by a dynamic proxy worker (204). In some implementations, the linked proxy worker becomes a “Deliverer” proxy worker (206) (hereinafter, also referred to as proxy worker (D)). In other implementations, the linked proxy worker is different than the proxy worker (D). Dynamic proxy workers can be temporary, dynamically distributed processes, which can be created by a control layer (or by devices or processes in the grid) and provided with orders and/or information for carrying out jobs in the grid. When a job is completed, the temporary, dynamic proxy worker can be terminated or assigned to another job by the control layer. An advantage of using temporary, dynamic proxies is that the user of the Web services cannot be identified or traced by a source device or service, thereby providing the user with anonymity and security when using the grid.

The proxy worker (D) receives a request for information or a service from the user device (208) and delivers the request to a control layer (210). The control layer analyzes the request (212) to determine one or more source devices for providing the requested information or service. The control layer determines at least one “Fetcher” proxy worker (hereinafter, also referred to as proxy worker (F)) to retrieve output from the determined source device or devices (214). The control layer provides the proxy worker (F) with the request and the addresses of the requesting user device and proxy worker (D) (216), so that requested output can be returned to the proxy worker (D) and the user device.

The proxy worker (F) sends the request to the determined source device(s) to be processed (218). The source devices can run one or more applications that can provide various Web services (e.g., search service, language translation service, mapping service, content streaming service). The request can include input parameters and other information that can be used by the service to process the request and provide output (e.g., a query for a search request, location information for a mapping service). The proxy worker (F) receives output from the source device(s) (220). In some implementations, the proxy worker (F) can make a new request based on output received from a source device (222). In some implementations, the proxy worker (F) shares output with at least one other proxy worker (F) (224).

The proxy worker (F) delivers the output directly to the proxy worker (D) and/or to the distributed infrastructure (226). In the latter case, the distributed infrastructure delivers the output to the proxy worker (D) (228). The proxy worker (D) bundles together output received from the distributed infrastructure (230) and delivers the output to the requesting user device (232). The proxy worker (D) sends status information to the control layer to indicate that the job has been completed (234). In some implementations, the status information includes information that the control layer can use to perform various administrative tasks, including but not limited to: accounting, metering, resetting proxy workers for other jobs, etc.

### Control Layer Example

FIG. 3 illustrates an example of a software architecture 300 for the control layer 104 of FIG. 1. In some implementations, the architecture 300 is a software stack that includes an information based process layer 302, a manager and service layer 304, a communication layer 306 and a network layer 308. The architecture 300 is one example of a software architecture. Other architectures are possible having more or fewer layers.

In some implementations, the information based process layer 302 provides discovery, trust, charging control, transactions, security, etc. For example, the information based process layer 302 can use Java® and XML to enable dynamic proxy brokers and workers 110 to communicate with each other through a service-redirection AP, and to control, negotiate and coordinate the sharing of information related to various functions (e.g., discovery, trust, charging, transaction and security) to meet the needs of Web service requirements initiated by user devices 108 or source devices 106 of the grid 100.

The manager and service layer 304 provides P2P management, resource management, job allocation to proxy workers, parsing and caching operations, service identification, etc. In the manager and service layer 304, Java and XML can be used to enable dynamic proxy brokers and workers 110 to communicate with each other to define the management and functions of each broker. Once a proxy broker is identified, the broker can communicate with one or more grid based resource brokers and workers to allocate jobs and tasks assigned by service and manager proxy brokers. In some implementations, the manager and service layer 304 uses a Java® based MSMU API, such as a service-redirection API, load-balance transaction API, proximization API, etc., to implement such functions.

The communication layer 306 implements communication protocols, such as, Hypertext Transfer Protocol (HTTP), File Transfer Protocol (FTP), Teletype Network (TELNET) protocol, etc. The network layer 308 provides a communication interface with the grid 100. Outputs from the network layer 308 can include orders and other information for controlling the grid, including but not limited to: proxy worker control, distributed infrastructure control, efficiency control, etc. Inputs to the network layer 308 can include but are not limited to: user input, service information, data and network information, etc.

### Open Source Building Blocks

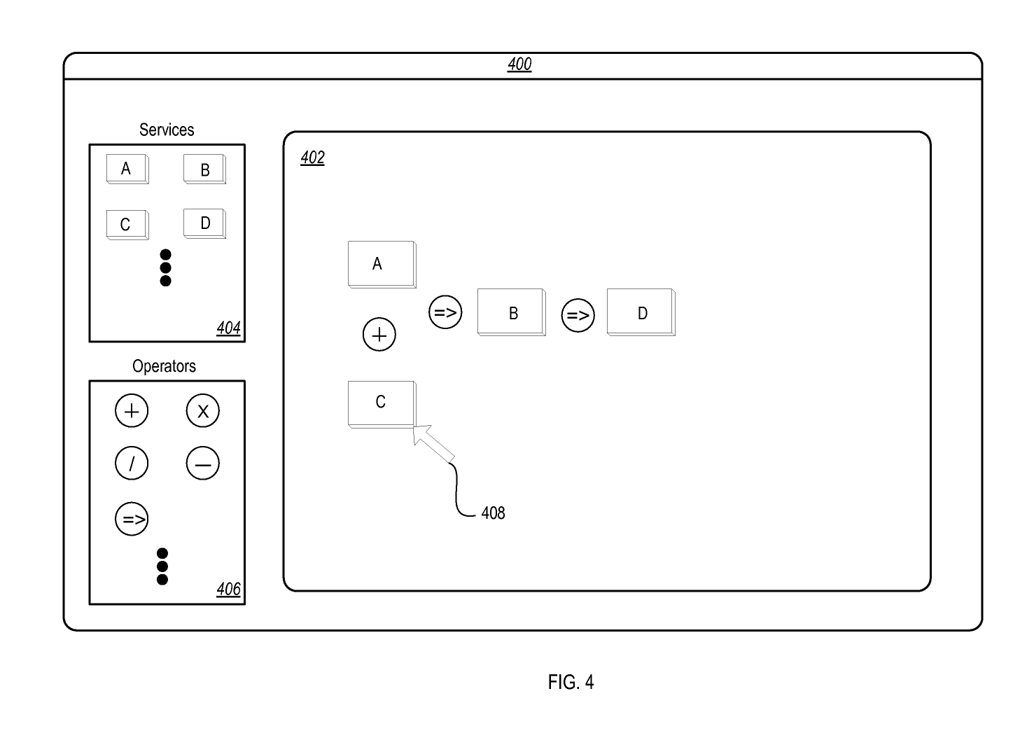

FIG. 4 illustrates an example of an open source building block service for use with the architecture and processes described in reference to FIGS. 1 and 2A-2C. In some implementations, users of the grid 100 are provided with a user interface 400 for manipulating and connecting open source building blocks to build a personalized virtualization configuration of Web services. In some implementations, open source building block services provide the personalized Web service virtualization. The building blocks can be compared to LEGO® building blocks, where the user can build a variety of personalized Web services from the building blocks.

In some implementations, the user interface 400 includes a work area 402, where the user can build a virtualization configuration from a set of basic Web services, which can be graphically represented as blocks in the user interface 400 using icons, graphics or images. The building blocks can be displayed in a panel 404 in the user interface 400. The building blocks can be dragged and dropped into the work area 400 using a mouse cursor 408 or other pointing device. The user can connect the building blocks using one or more logical operators, which can be displayed in a panel 406 in the user interface 400.

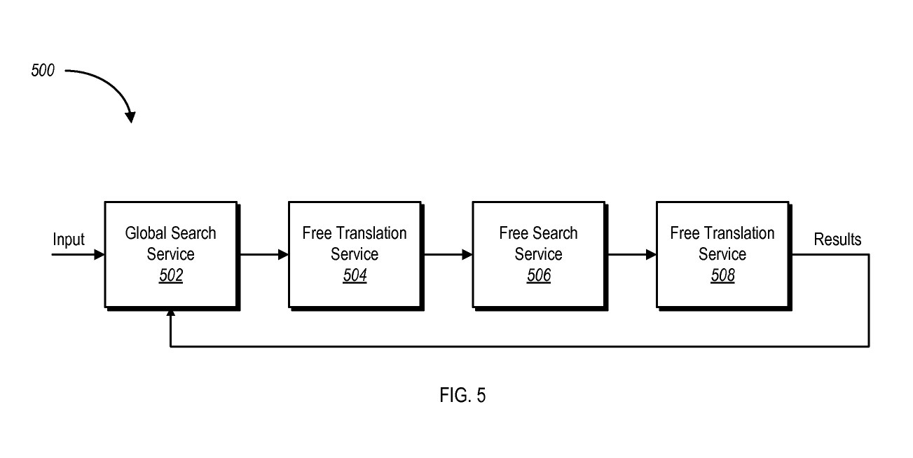

Some examples of basic services that can be represented by building blocks include but are not limited to: search services, language translation services, encyclopedia services, publication services, filter services, transform services, etc. Other services are possible. Some basic services are described in reference to FIGS. 5-11.

Some examples of operators for connecting basic service building blocks in the work area 402 include but are not limited to: +(integrate/add); ×(convert integrate), /(A/B: make A into format B); −(filter); and =>(input =>output). Other operators are possible.

In operation, a user can log-in to an application for personalized Web service virtualization provided by the grid 100. The user can be required to enter a password or other information for authentication. Upon successful login, the user can be provided with a desktop user interface 400. The user can select service blocks from the panel 400 and drag and drop the service blocks into the work area 402. The user can do the same with the operators displayed in the panel 406. The user can then drag the blocks and operators in the work area 402 to specify a personalized virtualization configuration of Web services.

In the example shown, the outputs of services A and C are added together and provided as input into service B. The output of service B is then provided as input into service D. For example, a user may combine the results of search services A and C using the “+” operator, and provide the combined output (e.g., a new search query) to a third search service B using the “=>” operator. The output of search service B (e.g., search results) can be input into a language translation service D using the “=>” operator. The language translation service D translates the output of search service B from a first language (e.g., English) to a second language (e.g., Korean). Using the foregoing procedure, the user can build a wide variety of personalized virtualization configurations using open source based basic for building block services.

### Global Search Service Example

FIG. 5 is a flow diagram illustrating an example of a global search service 500. In some implementations, the global search service 500 can provide searches for all kinds of information and data using free search services on the Web (e.g., Google®, Yahoo!®).

In some implementations, the service 500 begins when a user logs onto or otherwise accesses a search site (502). The user can provide input (e.g., a search query) in their native language (or any desired language) and initiate a search. The search input is delivered to a translation service (e.g., a free translation service), which translates the query from the native language (e.g., Korean) to one or more other languages (504), such as English, French, Spanish, Arabic, Chinese, Japanese, etc. The translated input is provided to one or more search services (506), which perform the searches using native language inputs and inputs translated to other languages. The results (e.g., raw data, homepages) from the search services can then be provided to the translation service (508), which translates the results into the native language, and returns the translated results to the global search site for presentation to the user.

Thus, the global search service allows a user to link to the grid 100 and request a search using input (e.g., a search query) in the user's native language. Transparent to the user, the input is translated into one or more different languages, so that a variety of search engine services geographically distributed within the grid can be used perform the requested search without regard to the native language of the user. The results from the search services can be provided as input into the translation service, which translates the results, which can be in multiple languages, into the user's native language. The results are then presented on the search site in the user's native language. The search and translation services can be provided automatically by the grid using hardware devices and software processes controlled by the grid. More particularly, search and translation services can be initiated by dynamic proxy workers that are created temporarily by the control layer 104. By using dynamic proxy workers, service level agreements or other contracts between the search and translation services can be avoided, since from the perspective of these services, the requestor of services appears to be an individual user. Nor does the grid require users to login to each system separately and submit separate requests for search and translation services.

### Global Encyclopedia Example

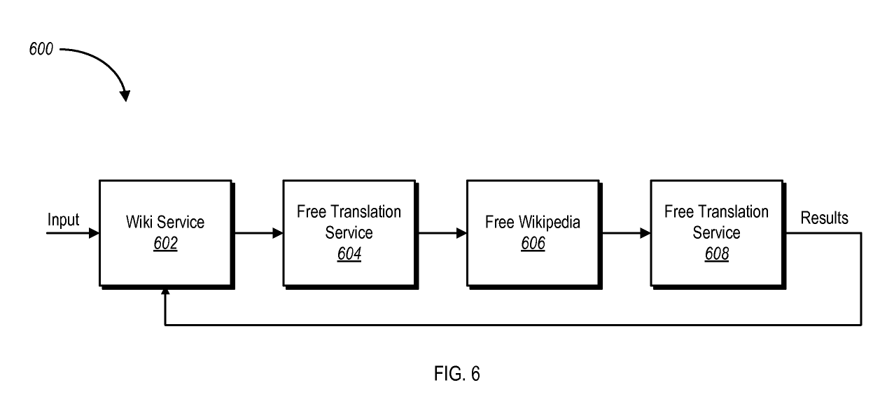

FIG. 6 is a flow diagram illustrating an example of a global encyclopedia service 600. In some implementations, the global encyclopedia service 600 provides a encyclopedia service for information and data with a translation service.

In some implementations, the service 600 begins when a user logs onto or otherwise accesses an encyclopedia site (602). The user provides input (e.g., a term or phrase) in their native language (or an desired language) and initiates a search. The search input is delivered to a translation service, which translates the query from the native language (e.g., Korean) to one or more different languages (604). The translated input is provided to one or more encyclopedia services (606) (e.g., wikipedia), which perform encyclopedia look-ups using the inputs in different languages. The results (e.g., raw data, homepages) from the free encyclopedia services can be provided to the translation service (608), which translates the results into the native language, and returns the translated results to the encyclopedia site for presentation to the user.

### Filtering Service Example

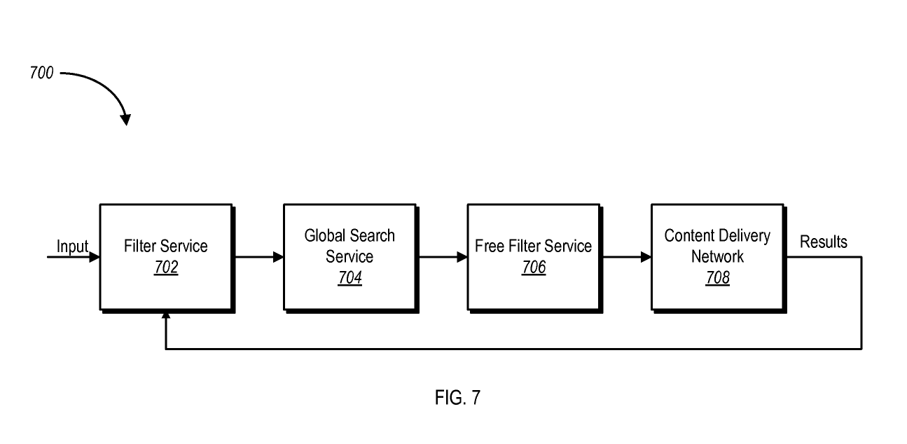

FIG. 7 is a flow diagram illustrating an example of a filter service 700 for providing filtering services for governments and other institutions that desire to censor information flowing to and from the grid. In some implementations, the service 700 begins when a representative of a government or institution logs onto or otherwise accesses a filter site (702). The representative can specify a filter policy, such that when a citizen or employee requests a search using the grid, the results of the search are processed by the filter site in accordance with the filter policy (704). In some implementations, the filter service is a distributed process, and outputs filtered content through a distributed content delivery network (706). The filtered results are returned to the user who requested the search (708).

### 3D Transform Service Example

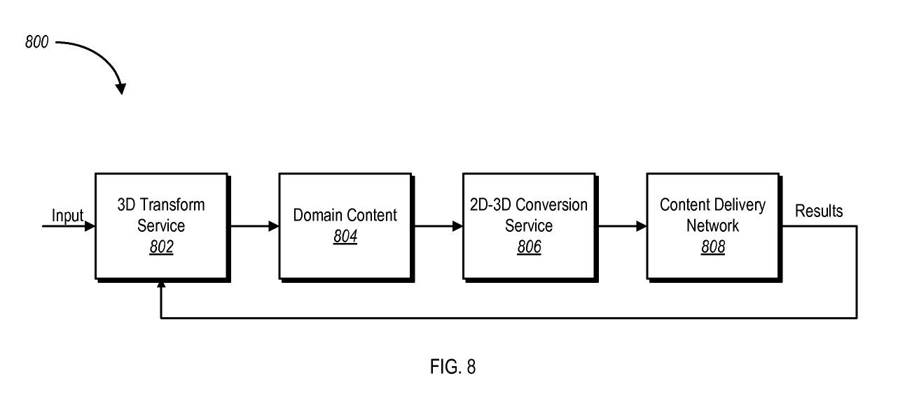

FIG. 8 is a flow diagram illustrating an example of a 3D transform service 800. In some implementations, the service 800 is 3D visual graphic service for information and data processed through the grid. The service 800 converts two-dimensional (2D) graphics into 3D graphics.

The process 800 begins when a user logs onto or otherwise accesses a 3D transform service site (802) and enters an input specifying a content location (e.g., a website domain name). Using the input, the service 800 fetches or crawls the contents of the Web site specified by the input (804). The contents are sent to a free 2D-3D conversion service site, which converts the contents from 2D to 3D (806). In some implementations, the conversion is performed using distributed processing, and the distributed results are delivered through a content delivery network (808) and returned to the user.

### Personalized Multimedia Content Studio Example

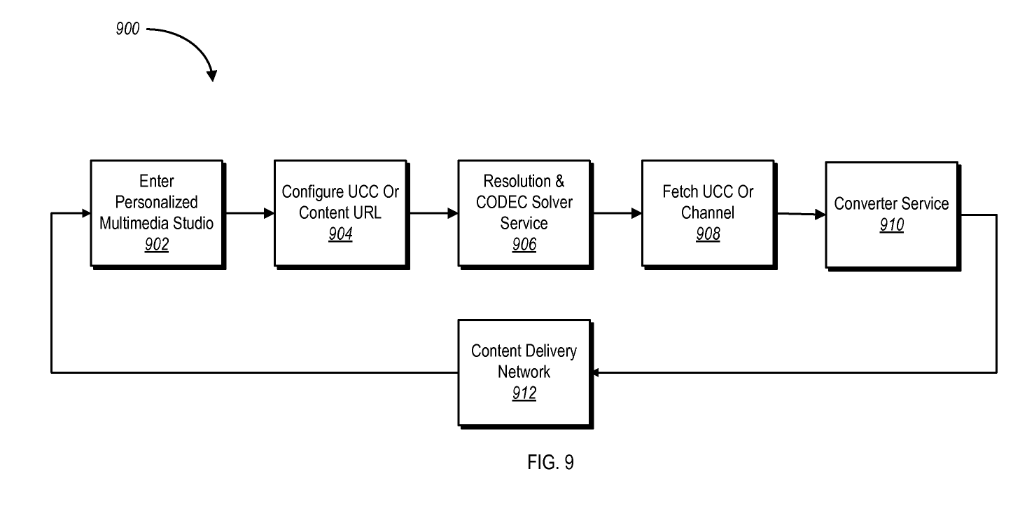

FIG. 9 is a flow diagram illustrating an example of a personalized multimedia content studio service 900. In some implementations, the service 900 provides users with one or more user interfaces for viewing and interacting with a variety of content sources (e.g., video, digital photos, audio). The process 900 begins when a user enters a virtual studio service site (902) and configures the site to present user created content (UCC) and/or a content URL for accessing content from a content source (904). In some implementations, the content is transmitted to a resolution and coding/decoding service site (906). The resolution and codec service provides Web services that convert codec formats and their associated resolutions based on the configuration of the requesting user device 106 and source service formats, in the situation where MSMU services are implemented.

The UCC and/or content channel is fetched (908) and sent to a converter service (910). The converter service converts the UCC and/or content channels and integrates them into the requested delivery formats. The content is then delivered to the user's personalized multimedia content studio through a content delivery network (912).

### Global Web Pen Pal Example

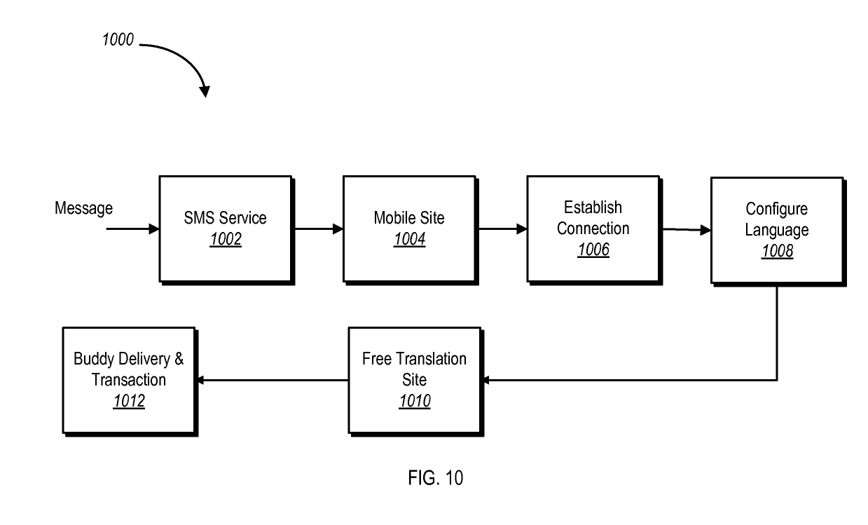

FIG. 10 is a flow diagram illustrating an example of a global Web pen pal service 1000. In some implementations, the service 1000 provides pen pal services in multiple languages. The service 1000 begins when a user submits a text message using, for example, Short Message Service (SMS) to one or more mobile devices linked to the grid (1002). The message enters a mobile site (1004). A buddy search is performed using, for example, SMS (1006). Connections are established with buddies (1008). Language is configured (1010) to determine input and output languages. The message is delivered to a free language translation site (1012) and results are returned. A buddy delivery and transaction is performed (1014).

### Global Publication Service Example

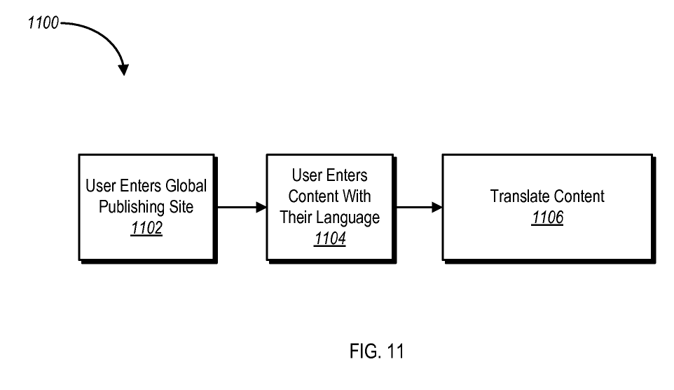

FIG. 11 is a flow diagram illustrating an example of a global publishing service 1100 with language translation capability. In some implementations, the service 1100 begins when a user logs onto or otherwise accesses a global publishing site to present a publication to a publication board (1102). The user enters their content with their language at the site (1104). The content is translated on-demand and ahead of demand, determined by, for example, a usage pattern (1106). The usage pattern can be determined by the user's configuration, the user's rights and/or publisher policy.

### Other Web Service Examples

In addition to the example services described above, there are many other Web services that can be provided by the grid 100. These Web services include but are not limited to: a global Universal Description, Discovery and Integration (UDDI) service which supports multiple languages and can be combined with other grid services; a UCC and media subtitle service with voice recognition and free translation; an advanced Web 3D art studio, which can be enabled by the integration of various Web services over a distributed infrastructure; a Web tracking service for tracking physical objects (e.g., a radio frequency ID (RFID) tracking service); social networking services; location based services; virtual organization (VO) management services; virtual global home and community services with 3D graphics and animation; location based Web OS translator service; second hand licensing transaction service; and any other service that is currently offered on the Web.

### Device Architecture Example

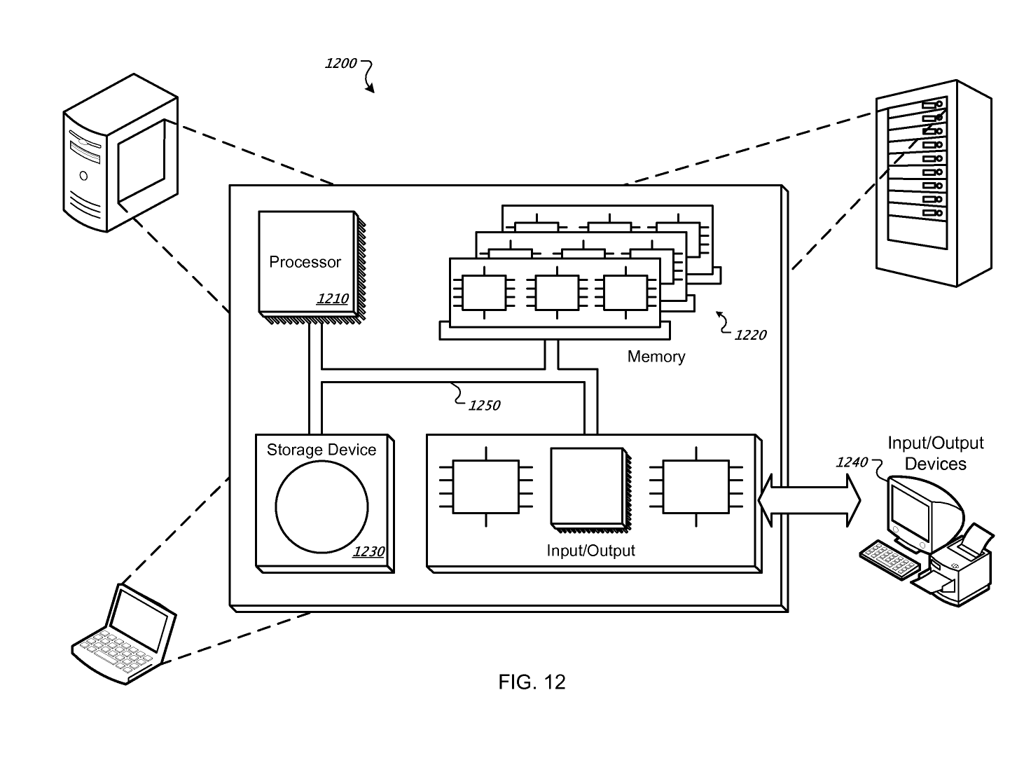

FIG. 12 is a block diagram illustrating an example of an architecture 1200 for a user device or source device, as described in reference to FIG. 1. In some implementations, the architecture 1200 includes a processor 1210, a memory 1220, a storage device 1230, and an input/output device 1240. Each of the components 1210, 1220, 1230, and 1240 are interconnected using a system bus 1250. The processor 1210 is capable of processing instructions for execution within the architecture 1200. In some implementations, the processor 1210 is a single-threaded processor. In other implementations, the processor 1210 can be a multi-threaded processor, a set of parallel processors, or one or more processors with multiple processing cores. The processor 1210 is capable of processing instructions stored in the memory 1220 or on the storage device 1230 to display graphical information for a user interface on the input/output device 1240.

The memory 1220 stores information within the architecture 1200. In one implementation, the memory 1220 is a computer-readable medium. In one implementation, the memory 1220 is a volatile memory unit. In another implementation, the memory 1220 is a non-volatile memory unit.

The storage device 1230 is capable of providing mass storage for the architecture 1200. In one implementation, the storage device 1230 is a computer-readable medium. In various different implementations, the storage device 1230 may be a floppy disk device, a hard disk device, an optical disk device, or a tape device.

The input/output device 1240 provides input/output operations for the architecture 1200. In one implementation, the input/output device 1240 includes a keyboard and/or pointing device. In another implementation, the input/output device 1240 includes a display unit for displaying graphical user interfaces.

The disclosed embodiments can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”), a wide area network (“WAN”), the Internet, an intranet, a wireless network, etc.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments of the invention have been described. Nevertheless, it will be understood that various modifications may be made without departing from the spirit and scope of the invention.

What is claimed is:

1. A multi-source, multi-use grid system comprising:
a distributed infrastructure; and
a processor coupled to the distributed infrastructure and operable for creating a control layer for managing at least one temporary, dynamic proxy for establishing a temporary link between a user device and a source device, where the link is operable for providing the user device with access to a service or information provided by or through the source device.

2. The system of claim 1, where the control layer further comprises:
a process layer operable for enabling information sharing between a number of the dynamic proxies, where the shared information is related to service requests of user devices or source devices of the grid system;
a manager and service layer operable for providing peer-to-peer network management;
a communication layer operable to implement communication protocols; and
a network layer operable to provide a communication interface with the grid system.

3. The system of claim 1, where the service can be one or more services from a group of services including: searching, language translation, graphical transformations, filtering, content creation, content distribution, messaging and publishing.

4. The system of claim 1, where the dynamic proxy is a dynamically distributed process created by the control layer for performing one or more jobs throughout the grid system.

5. The system of claim 1, where the control layer is created and used by grid brokers which communicate with each other using an application programming interface (API).

6. The system of claim 5, where the grid brokers communicate or control each other in the control layer, and a first broker uses the API to virtualize a second broker as a proxy worker.

7. A multi-source, multi-use (MSMU) grid computing method comprising:
receiving a request from a user device for information or a service available through the MSMU grid; and
assigning a temporary, dynamic proxy to the request for establishing a link with one or more sources coupled to the MSMU grid for providing the information or service.

8. The method of claim 7, where receiving a request further comprises:
confirming a communication link between the user device and a first proxy worker;
receiving the request from the first proxy worker for the information or service;
analyzing the request to determine one or more sources for processing the request;
determining at least one second proxy worker to fetch the requested information or service results from the service from the one or more sources, and providing the second proxy worker with the request and addresses of the user device and the first proxy worker;
managing the transfer of information and service results from the second proxy worker to the first proxy worker; and
receiving status information from first proxy worker when the information or service results have been delivered to the user device.

9. The method of claim 7, where a service is requested that comprises:
performing a first service based on a first input associated with a first language;
translating the first input into a second input associated with a second language that is different than the first language;
performing a second service based on the second input and receiving an output associated with the second language;
translating the output from the second language into the first language; and
delivering the translated output to the user device.

10. The method of claim 9, where the service is related to one or more of searching, language translation, graphical transformation, filtering, content creation, content distribution, messaging and publishing.

11. A computer-readable medium having instructions stored thereon, which, when executed by a processor, causes the processor to perform operations comprising:
receiving a request from a user device for information or a service available through a multi-source, multi-use (MSMU) grid; and
assigning a temporary, dynamic proxy to the request for establishing a link with one or more sources coupled to the MSMU grid for providing the information or service.

12. The computer-readable medium of claim 11, where receiving a request further comprises:
confirming a communication link between the user device and a first proxy worker;
receiving the request from the first proxy worker for the information or service;
analyzing the request to determine one or more sources for processing the request;
determining at least one second proxy worker to fetch the requested information or service results from the service from the one or more sources, and providing the second proxy worker with the request and addresses of the user device and the first proxy worker;
managing the transfer of information and service results from the second proxy worker to the first proxy worker; and
receiving status information from first proxy worker when the information or service results have been delivered to the user device.

13. The computer-readable medium of claim 11, where a service is requested that comprises:
performing a first service based on a first input associated with a first language;
translating the first input into a second input associated with a second language that is different than the first language;
performing a second service based on the second input and receiving an output associated with the second language;
translating the output from the second language into the first language; and
delivering the translated output to the user device.

14. The computer-readable medium of claim 13, where the service is related to one or more of searching, language translation, graphical transformation, filtering, content creation, content distribution, messaging and publishing.

15. A multi-source, multi-use (MSMU) grid system, comprising:
an interface operable for receiving a request from a user device for information or a service available through the MSMU grid system; and
a processor coupled to the interface and operable for assigning a temporary, dynamic proxy to the request for establishing a link with one or more sources coupled to the MSMU grid for providing the information or service.

16. The system of claim 15, where receiving a request further comprises:
confirming a communication link between the user device and a first proxy worker;
receiving the request from the first proxy worker for the information or service;
analyzing the request to determine one or more sources for processing the request;
determining at least one second proxy worker to fetch the requested information or service results from the service from the one or more sources, and providing the second proxy worker with the request and addresses of the user device and the first proxy worker;
managing the transfer of information and service results from the second proxy worker to the first proxy worker; and
receiving status information from first proxy worker when the information or service results have been delivered to the user device.

17. The system of claim 15, where a service is requested that comprises:
performing a first service based on a first input associated with a first language;
translating the first input into a second input associated with a second language that is different than the first language;
performing a second service based on the second input and receiving an output associated with the second language;
translating the output from the second language into the first language; and
delivering the translated output to the user device.

18. The system of claim 17, where the service is related to one or more of searching, language translation, graphical transformation, filtering, content creation, content distribution, messaging and publishing.
